(19) United States
(12) Patent Application Publication
(10) Pub. No.: US 2018/0289178 A1
(43) Pub. Date: Oct. 11, 2018

(54) DISPLAY SHELVING WITH SHELVES FORMED BY FOLDING IN OPPOSITE DIRECTIONS

(71) Applicant: DIAMOND DISPLAY GROUP PARTNERS, INC., Plano, TX (US)

(72) Inventors: Tina MCMILLAN-SWEAT, Royse City, TX (US); Robert C. WHEAT, McKinney, TX (US)

(21) Appl. No.: 15/945,187

(22) Filed: Apr. 4, 2018

Related U.S. Application Data
(60) Provisional application No. 62/483,247, filed on Apr. 7, 2017.

(51) Int. Cl. A47F 5/11; B31D 5/00

(52) U.S. Cl. CPC A47F 5/116; B31D 5/00

(57) ABSTRACT

A display shelving can include a front panel, a back panel, and side panels connecting the front panel to the back panel. A shelf is connected to the front panel along a fold line, and the shelf is engaged with the back panel. Another shelf is connected to the back panel along another fold line, and the shelf is supported by the side panels. A method of producing a display shelving can include securing an inner back panel to an outer back panel, with the inner and outer back panels overlying each other, connecting a front panel to the inner and outer back panels with side panels, folding a shelf section of the front panel toward the inner and outer back panels, and folding another shelf section of the inner back panel toward the front panel.

### CROSS-REFERENCE TO RELATED APPLICATION

This application claims the benefit under 35 USC § 119 of the filing date of U.S. provisional application No. 62/483,247 filed on 7 Apr. 2017. The entire disclosure of the prior application is incorporated herein by this reference.

### BACKGROUND

This disclosure relates generally to display shelving and methods for producing same. In an example described below, this disclosure more particularly provides a display shelving with shelves alternately folded from a front and a back of the display shelving.

Display shelving may be used to contain and display products for sale in retail establishments. Frequently, display shelving is not intended to be a permanent fixture in a retail establishment, and so it is beneficial for the display shelving to be economical to fabricate and assemble or erect.

Note, however, it is not necessary for display shelving to be used in a retail establishment, for products to be displayed for sale, or for the display shelving to be only temporarily used. Thus, the scope of this disclosure is not limited to non-permanent product display shelving to be used in retail establishments.

### BRIEF DESCRIPTION OF THE DRAWINGS

FIG. 1 is a representative unfolded view of an example of a one-piece display shelving blank which can embody principles of this disclosure.

FIGS. 2-15 are representative perspective views of a sequence of steps in an example method for erecting a display shelving example from the display shelving blank.

FIG. 16 is a representative perspective view of the erected display shelving example.

### DETAILED DESCRIPTION

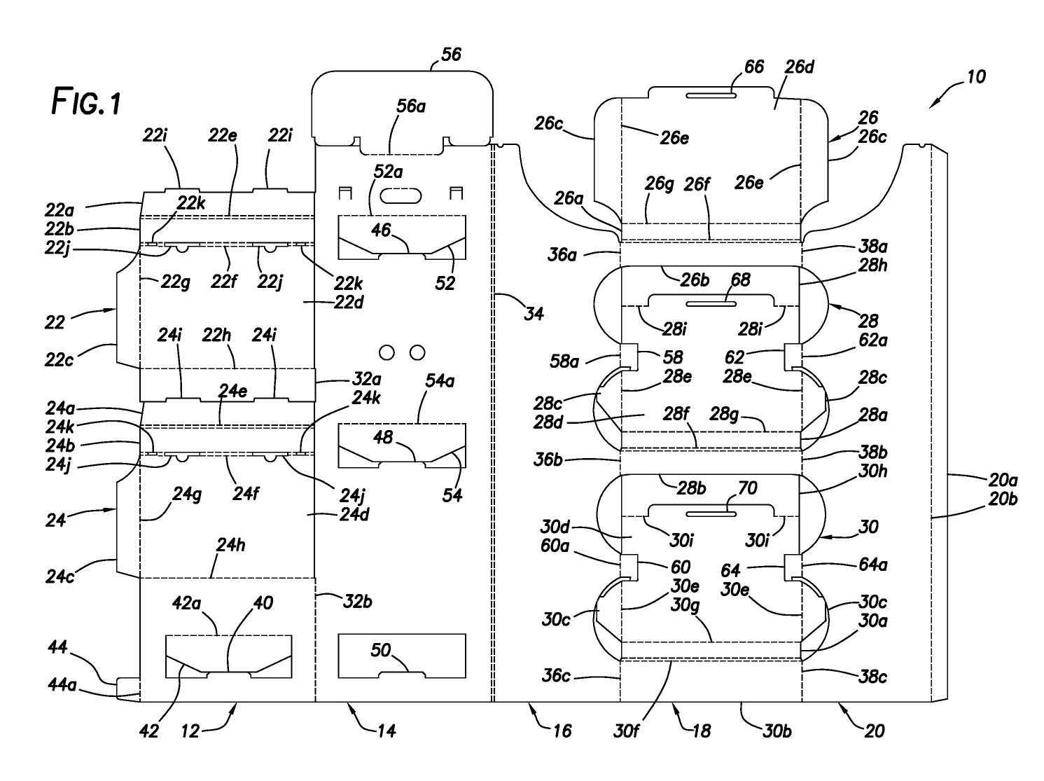

Representatively illustrated in FIG. 1 is a one-piece display shelving blank 10 which can embody principles of this disclosure. However, it should be clearly understood that the blank 10, and an associated method of producing a display shelving, are merely one example of an application of the principles of this disclosure in practice, and a wide variety of other examples are possible. Therefore, the scope of this disclosure is not limited at all to the details of the blank 10, method and resulting display shelving as described herein and/or depicted in the drawings.

The blank 10 can be made of a corrugated board material. In some examples, the material could be CORROPLAST™ (a plastic corrugated board), folding carton board and/or any type of pliable material that can be appropriately folded. The scope of this disclosure is not limited to any particular material(s) selected for the blank 10.

In FIG. 1, broken lines are used to indicate fold lines, and solid lines are used to indicate cut lines. Some or all of the fold lines may be perforated, scored and/or creased to facilitate ease and accuracy of folding.

In the FIG. 1 example, a back of the erected display shelving comprises an inner back panel 12 that folds and glues to an outer back panel 14 to provide full shelves that pull away from the back of the display shelving and wrap around locking tabs in a front of the display shelving. In some examples, the inner back panel 12 could be provided as a separate blank that is glued or otherwise attached to the outer back panel 14.

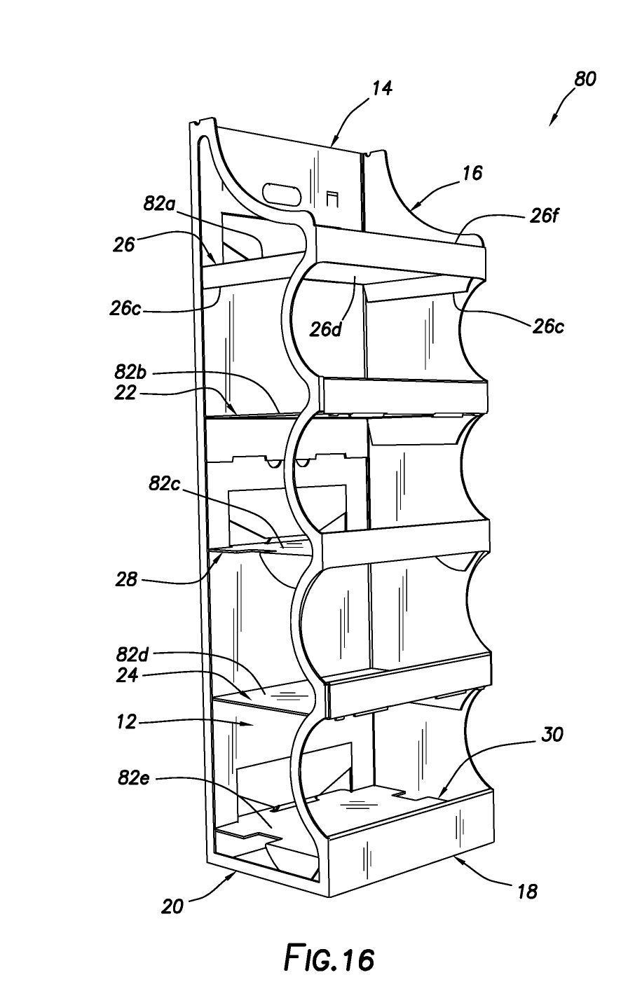

As described more fully below for the FIG. 1 example, one piece of corrugated board material can be used to form full shelves from the back, and full shelves from the front, to form one complete display shelving. Thus, the two shelf activation process (folding shelves from both the front and the back) uses only one piece of corrugated board material to produce the display shelving in this example (see FIG. 16).

As representatively illustrated in FIG. 1, the blank 10 comprises the inner and outer back panels 12, 14, a right side panel 16, a front panel 18 and a left side panel 20. The inner back panel 12 and the outer back panel 14 are joined along fold lines 32a,b. The outer back panel 14 and the right side panel 16 are joined along fold line 34. The right side panel 16 is joined to the front panel 18 along fold lines 36a-c. The front panel 18 is joined to the left side panel 20 along fold lines 38a-c. Note that the left and right positions of the side panels 16, 20 could be reversed in other examples.

The inner back panel 12 includes upper and lower shelf sections 22, 24, and the front panel 18 includes upper, middle and lower shelf sections 26, 28, 30. Thus, the erected display shelving will have a total of five shelves. However, in other examples, other numbers and positions of shelves could be provided.

The shelf sections 22, 24 of the inner back panel 12 include front lip sections 22a,b and 24a,b, support tabs 22c and 24c, and shelf bases 22d and 24d, respectively. Fold lines 22e and 24e join the front lip sections 22a,b and 24a,b, respectively. Fold lines 22f and 24f join the front lip sections 22b and 24b to the shelf bases 22d and 24d, respectively. Fold lines 22g and 24g join the support tabs 22c and 24c to the shelf bases 22d and 24d, respectively. Fold lines 22h and 24h join the shelf bases 22d and 24d, respectively, to the remainder of the inner back panel 12.

The front lip sections 22a and 24a have tabs 22i and 24i formed thereon, respectively. The tabs 22i and 24i are configured to cooperatively engage slots 22j and 24j, respectively, formed in the shelf sections 22 and 24.

The inner back panel 12 further has an upwardly facing tab 40 and a downwardly facing locking tab 42 formed therein. The locking tab 42 is joined to the remainder of the back panel 12 along a fold line 42a. Another optional tab 44 is joined to the remainder of the inner back panel 12 along a fold line 44a.

The outer back panel 14 has upwardly facing tabs 46, 48, 50 and downwardly facing locking tabs 52, 54 formed therein. The locking tabs 52 and 54 are joined to the remainder of the outer back panel 14 along fold lines 52a and 54a, respectively. An optional foldable display panel 56 (e.g., for displaying an advertisement or notice) is joined to the remainder of the outer back panel 14 along a fold line 56a.

The right side panel 16 includes locking tabs 58, 60. The locking tabs 58 and 60 are joined to the remainder of the right side panel 16 along fold lines 58a and 60a, respectively.

Similarly, the left side panel 20 includes locking tabs 62, 64. The locking tabs 62 and 64 are joined to the remainder of the left side panel 20 along fold lines 62a and 64a, respectively. The left side panel 20 further includes a vertical tab 20a joined to the remainder of the left side panel along a fold line 20b.

The upper, middle and lower shelf sections 26, 28 and 30 of the front panel 18 include respective front lip sections 26a,b, 28a,b and 30a,b. The shelf sections 26, 28 and 30 further include support tabs 26c, 28c and 30c formed thereon, respectively.

The support tabs 26c, 28c and 30c are joined to respective shelf bases 26d, 28d and 30d along respective fold lines 26e, 28e and 30e. The front lip sections 26a,b, 28a,b and 30a,b are respectively joined to each other along fold lines 26f, 28f and 30f. The front lip sections 26a, 28a and 30a are joined to the shelf bases 26d, 28d and 30d along fold lines 26g, 28g and 30g, respectively. Optional support tabs 28h and 30h are joined to the shelf bases 28d and 30d along fold lines 28i and 30i, respectively.

Slots 66, 68 and 70 are formed through the shelf bases 26, 28 and 30, respectively. The slots 66, 68 and 70 are configured for cooperative engagement by the respective tabs 46, 48 and combined 40 and 50, when the display shelving is erected. The locking tabs 52, 54 and 42 will then prevent disengagement of the tabs 46, 48, and combined 40 and 50, respectively.

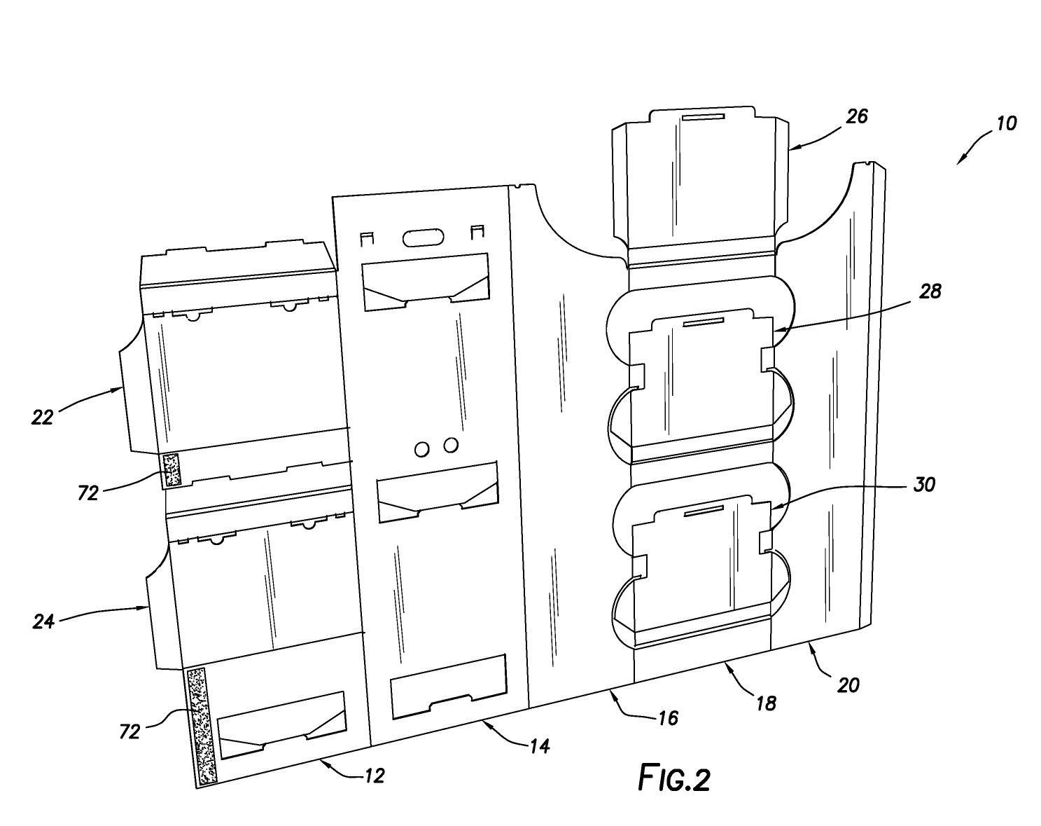

Referring additionally now to FIG. 2, an initial step in an example method of erecting the display shelving is representatively illustrated. In this view, it may be seen that a glue or other adhesive 72 has been applied to the inner back panel 12 near a leftmost edge thereof (as viewed in FIG. 2). Note that the adhesive 72 is not applied to the shelf sections 22, 24.

The adhesive 72 is used in this example to secure the inner back panel 12 to the outer back panel 14, as described more fully below. Any suitable adhesive, glue or other bonding agent may be used for the adhesive 72.

In other examples, the adhesive 72 could be applied to the outer back panel 14. In some examples, attachment means or devices (such as permanent or releasable attachment devices or fasteners, hook-and-loop strips, etc.) could be used instead of the adhesive 72.

Note that the display panel 56 and the support tabs 28h, 30h are not used in this example of the blank 10.

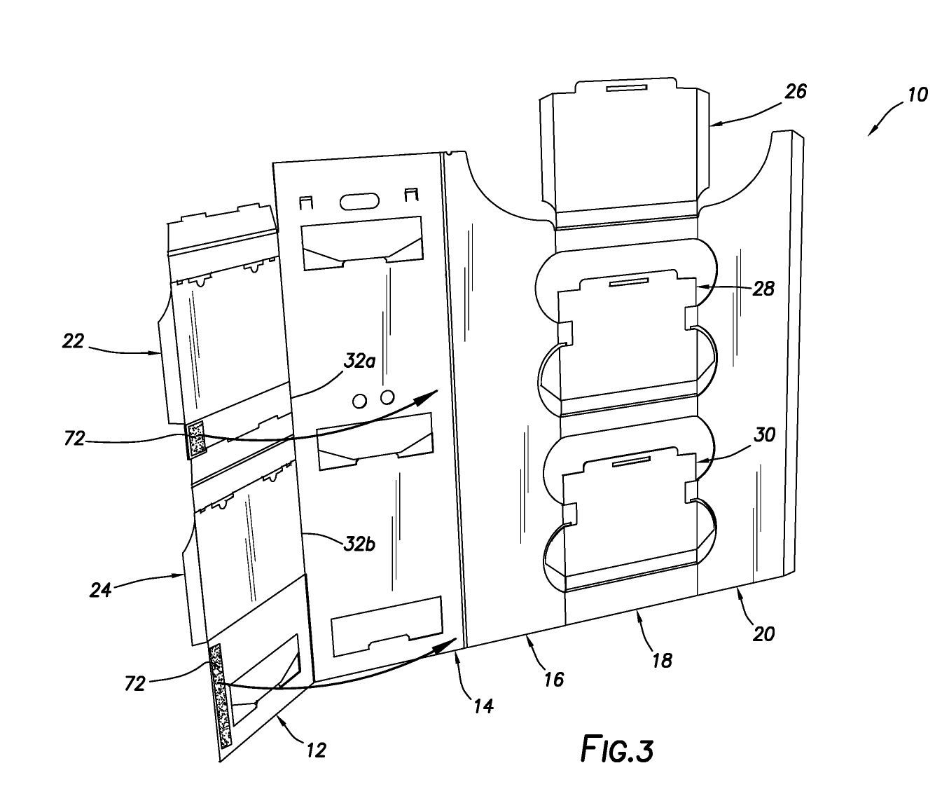

Referring additionally now to FIG. 3, a subsequent step of the method is representatively illustrated. In this view, it may be seen that the inner back panel 12 is folded toward the outer back panel 14 at fold lines 32a,b. In this manner, the adhesive 72 is brought into contact with an inner surface of the outer back panel 14.

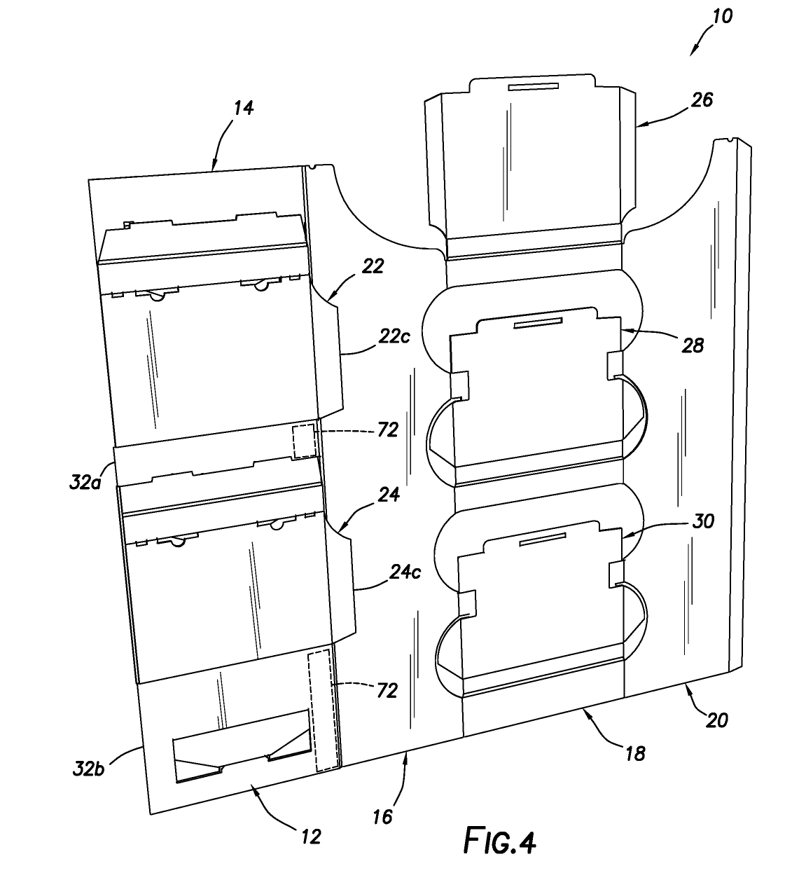

Referring additionally now to FIG. 4, a subsequent step of the method is representatively illustrated. In this view, it may be seen that the inner back panel 12 is now secured to the outer back panel 14 by the adhesive 72. Note that the support tabs 22c, 24c now overlie the right side panel 16.

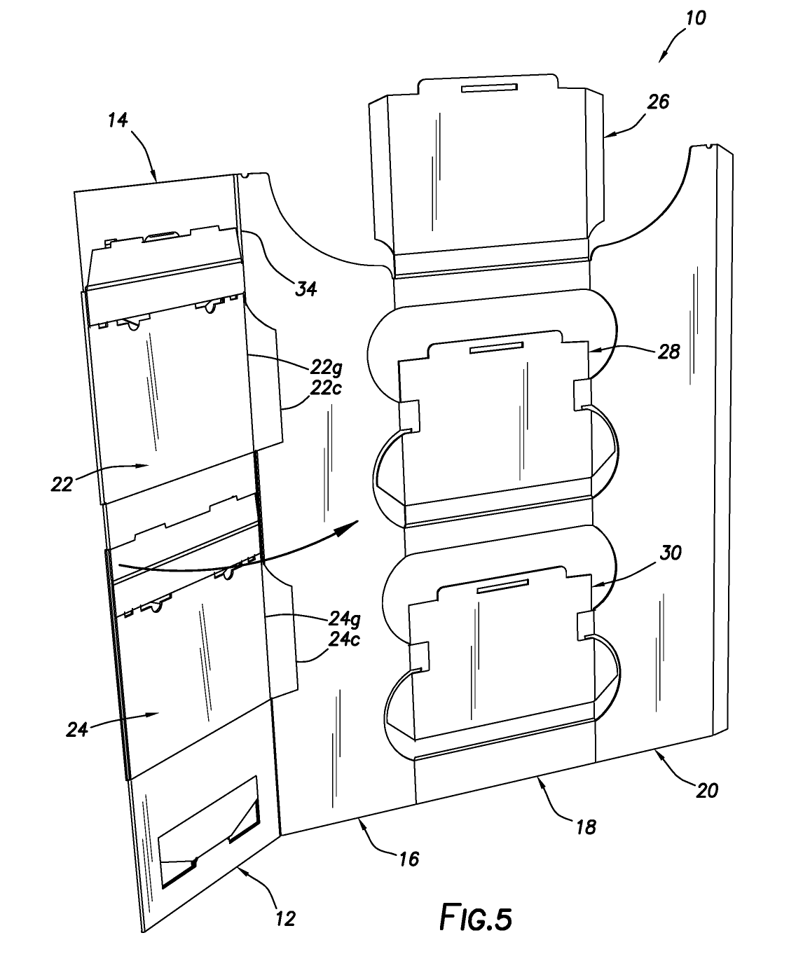

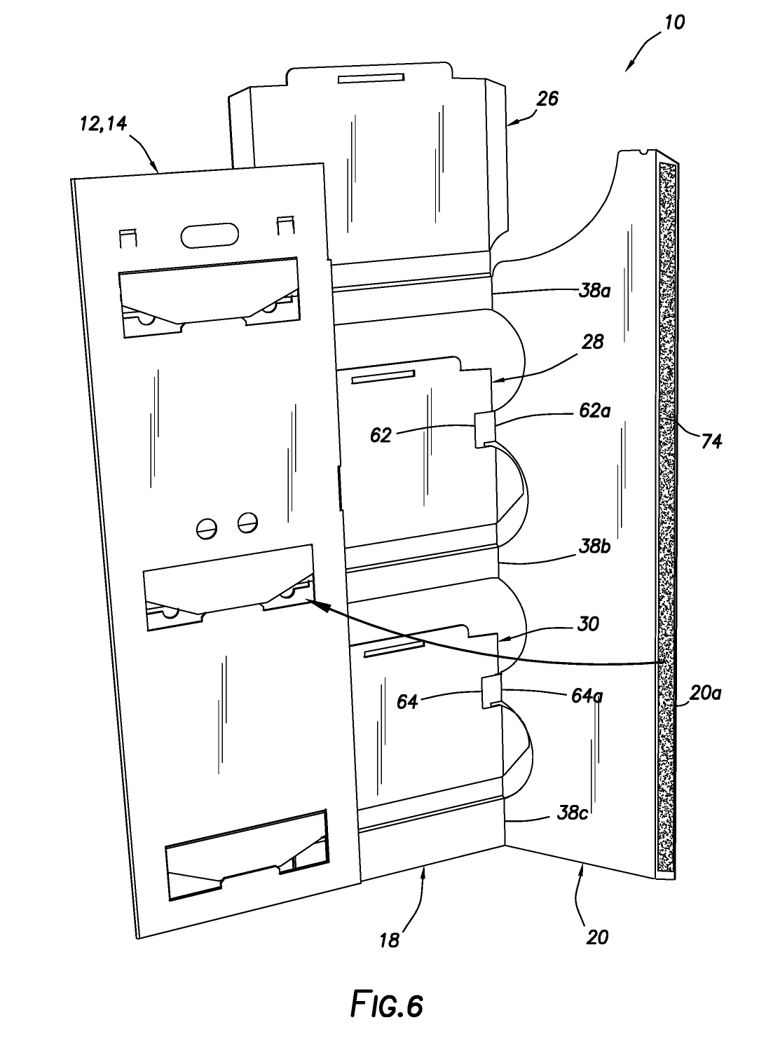

Referring additionally now to FIG. 5, a subsequent step of the method is representatively illustrated. In this view, it may be seen that the combined inner and outer back panels 12, 14 are folded toward the right side panel 16 at fold line 34, until the back panels overlie the right side panel (see FIG. 6). Since the support tabs 22c, 24c overlie the right side panel 16, the tabs 22c, 24c are folded at fold lines 22g, 24g relative to the combined inner and outer back panels 12, 14.

Referring additionally now to FIG. 6, a subsequent step of the method is representatively illustrated. In this view, it may be seen that a glue or adhesive 74 has been applied to the tab 20a of the left side panel 20.

The adhesive 74 may be the same or a different adhesive, glue, bonding agent or fastener (whether permanent or releasable) as the adhesive 72 described above. The adhesives 72, 74 may be applied at any time.

As depicted in FIG. 6, the left side panel 20 is folded toward the combined inner and outer back panels 12, 14 at fold lines 38a-c. The tabs 62, 64 may also be folded at fold lines 62a, 64a in this step.

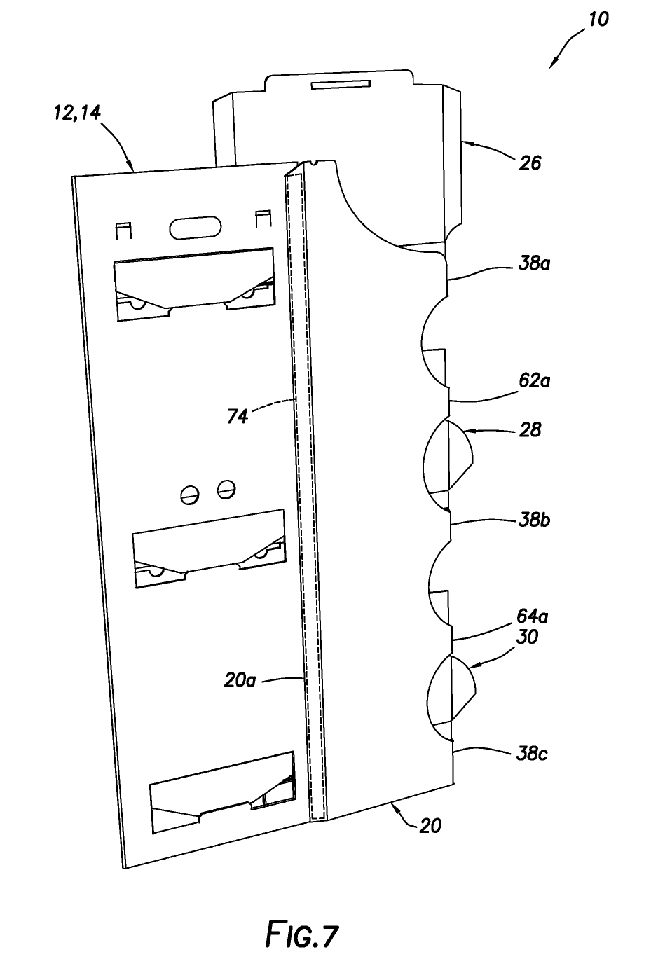

Referring additionally now to FIG. 7, a subsequent step of the method is representatively illustrated. In this view, it may be seen that the adhesive 74 now secures the tab 20a of the left side panel 20 to the outer back panel 14.

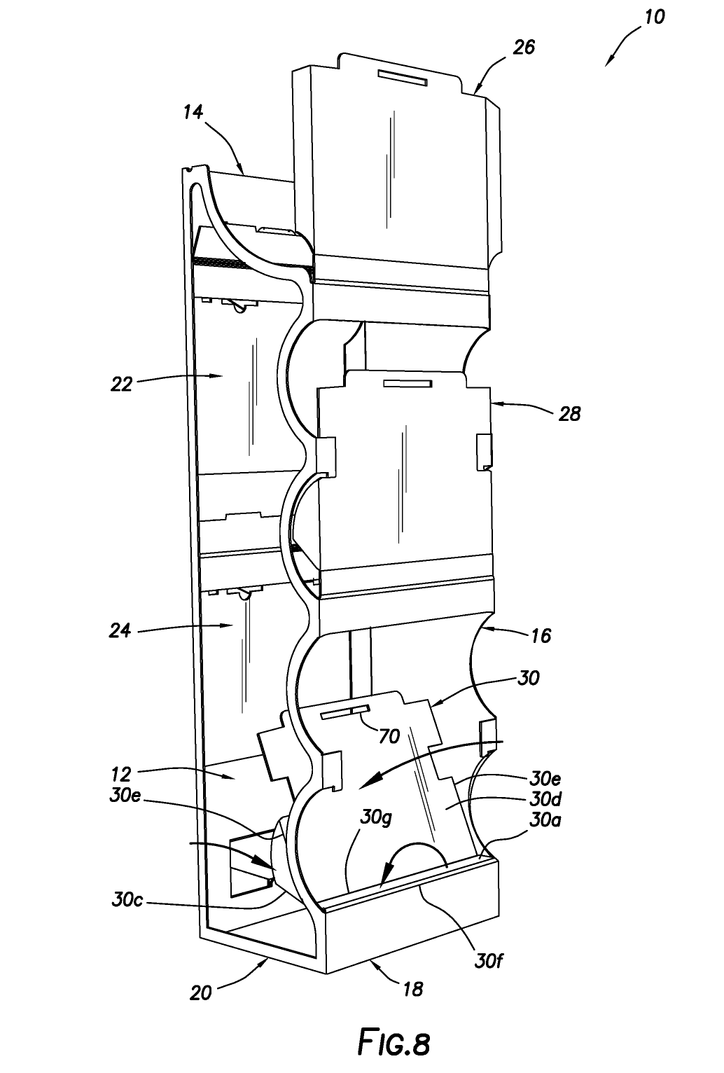

Referring additionally now to FIG. 8, a subsequent step of the method is representatively illustrated. In this view, it may be seen that the panels 12, 14, 16, 18, 20 have been expanded, so that the panels now form upstanding walls of the eventual erected display shelving. The left side panel 20 is cut away in this and following views of the method, so that an interior of the display shelving is visible.

The support tabs 30c of the lower shelf section 30 are folded downward at fold lines 30e. The lower shelf section 30 is then folded inward toward the inner back panel 12 at fold line 30f. Simultaneously, the lower shelf base 30d is folded toward the lip section 30a at fold line 30g. In this manner, the lip section 30a and a lower portion of the front panel 18 form an upstanding lip at a front of the lower shelf base 30d.

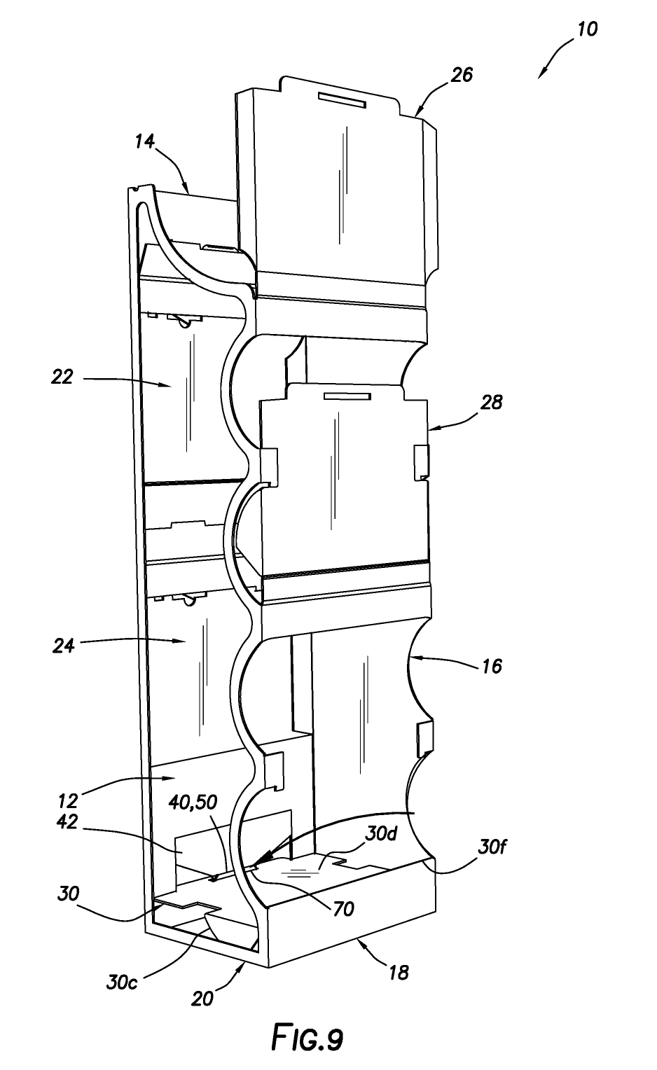

Referring additionally now to FIG. 9, a subsequent step of the method is representatively illustrated. In this view, it may be seen that the shelf base 30d is now in a horizontal orientation, and the tabs 40, 50 of the inner and outer back panels 12 have been received in the slot 70 in the lower shelf section 30. The locking tab 42 prevents inadvertent dislodging of the tabs 40, 50 from the slot 70.

Note that a front of the shelf base 30d is supported by the lip section 30a (see FIG. 8), right and left sides of the shelf base are supported by the support tabs 30c, and a rear of the shelf base is supported by the engagement between the tabs 40, 50 and the slot 70. If the support tab 30h (see FIG. 2) is used, this support tab will also support the rear of the shelf base 30d.

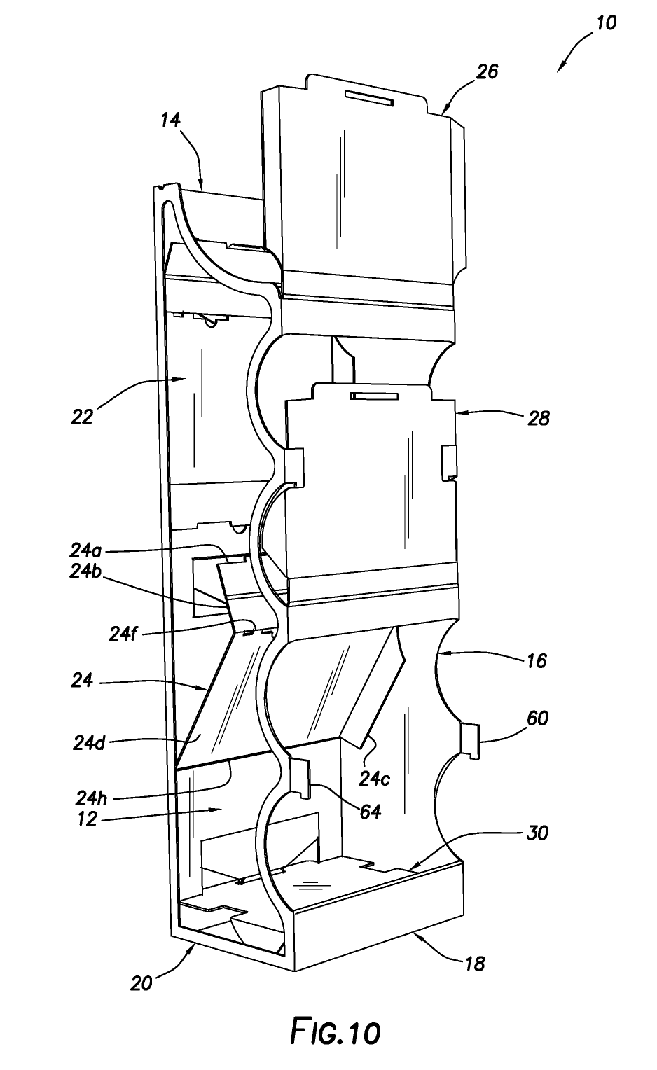

Referring additionally now to FIG. 10, a subsequent step of the method is representatively illustrated. In this view, it may be seen that the lower shelf section 24 is folded downward at fold line 24h. Simultaneously, the lip sections 24a,b are folded at fold line 24f relative to the shelf base 24d. Note that the locking tabs 60, 64 of the right and left side panels 16, 20 extend forward to permit the lip sections 24a,b to rotate past the locking tabs.

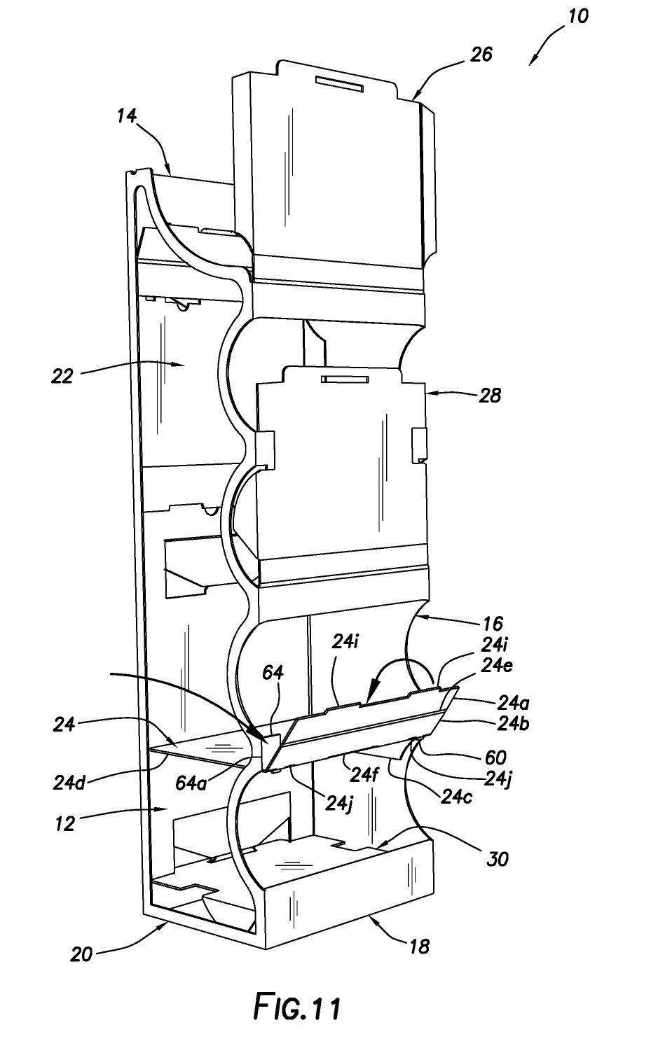

Referring additionally now to FIG. 11, a subsequent step of the method is representatively illustrated. In this view, it may be seen that the locking tabs 60, 64 are folded toward each other at fold lines 60a, 64a. The locking tabs 60, 64 engage the slots 24k in the lower shelf section 24 as the lip sections 24a,b are folded upward at fold line 24f. The shelf base 24d is in a horizontal orientation at this point.

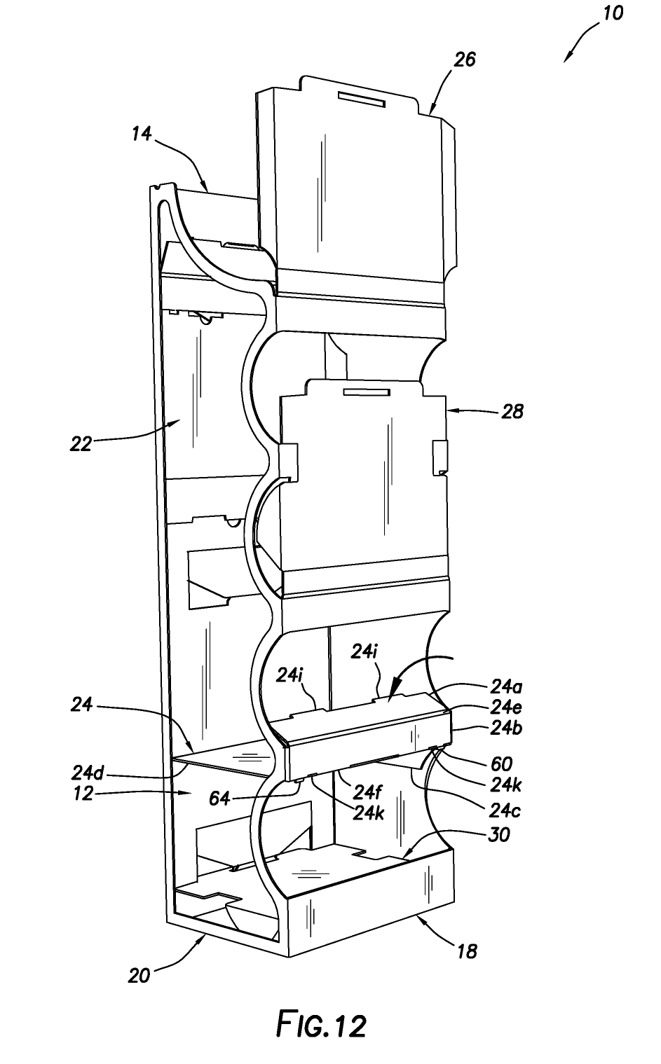

Referring additionally now to FIG. 12, a subsequent step of the method is representatively illustrated. In this view, it may be seen that the lip section 24a is folded inward at fold line 24e relative to the lip section 24b.

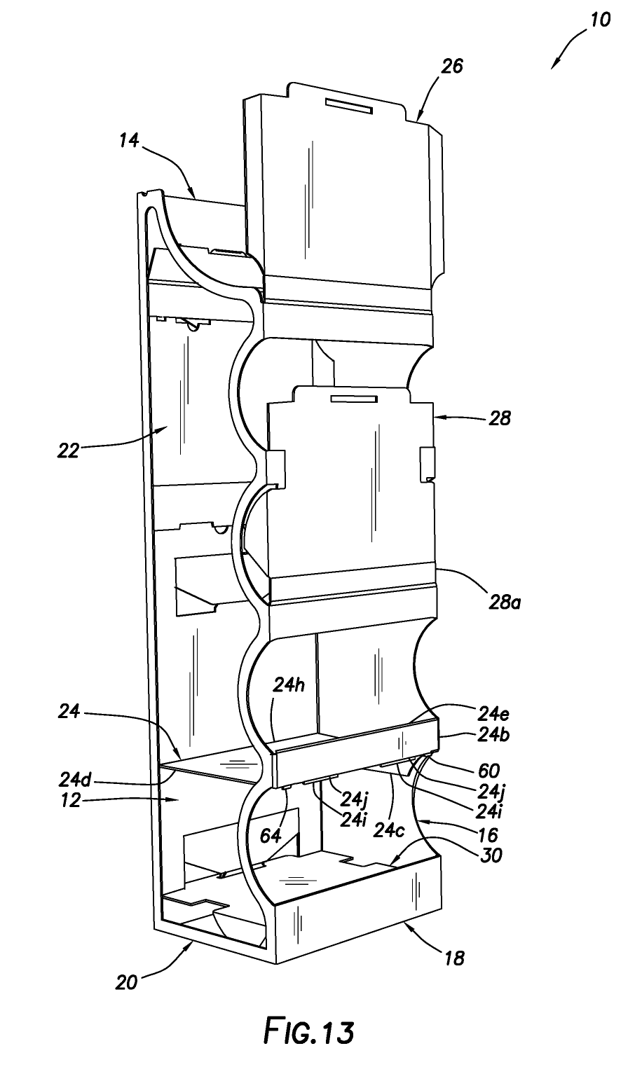

Referring additionally now to FIG. 13, a subsequent step of the method is representatively illustrated. In this view, it may be seen that the tabs 24i are now engaged in the slots 24j. This secures the lip sections 24a,b in an upstanding position at a forward side of the shelf base 24d.

Note that the shelf base 24d is supported at its forward side by the lip sections 24a,b, which are in turn supported by the locking tabs 60, 64 positioned between the lip sections. The shelf base 24d is also supported at a rear side along the fold line 24h by the inner back panel 12. On its right side, the shelf base 24d is supported by the support tab 24c. A similar tab could be provided in other examples to support a left side of the shelf base 24d.

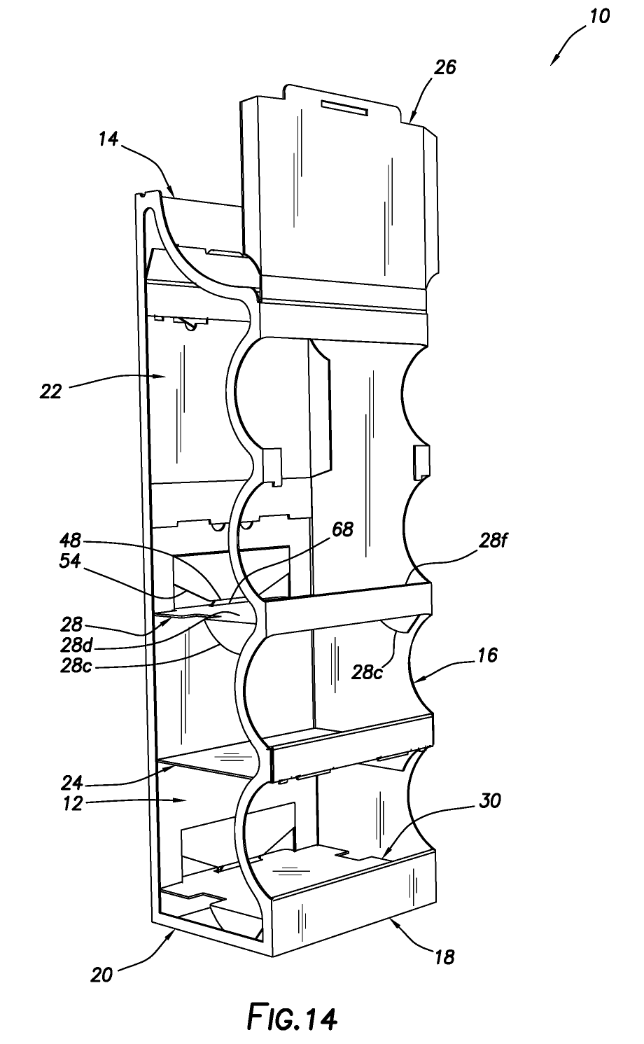

Referring additionally now to FIG. 14, a subsequent step of the method is representatively illustrated. In this view, it may be seen that the shelf section 28 has been folded in a manner similar to that described above for the shelf section 30. The shelf base 28d is now in a horizontal orientation, and the slot 68 is engaged by the tab 48, with the locking tab 54 preventing inadvertent dislodging of the slot from the tab. The shelf base 28d is supported at its forward, rear and sides as described above for the shelf base 30d.

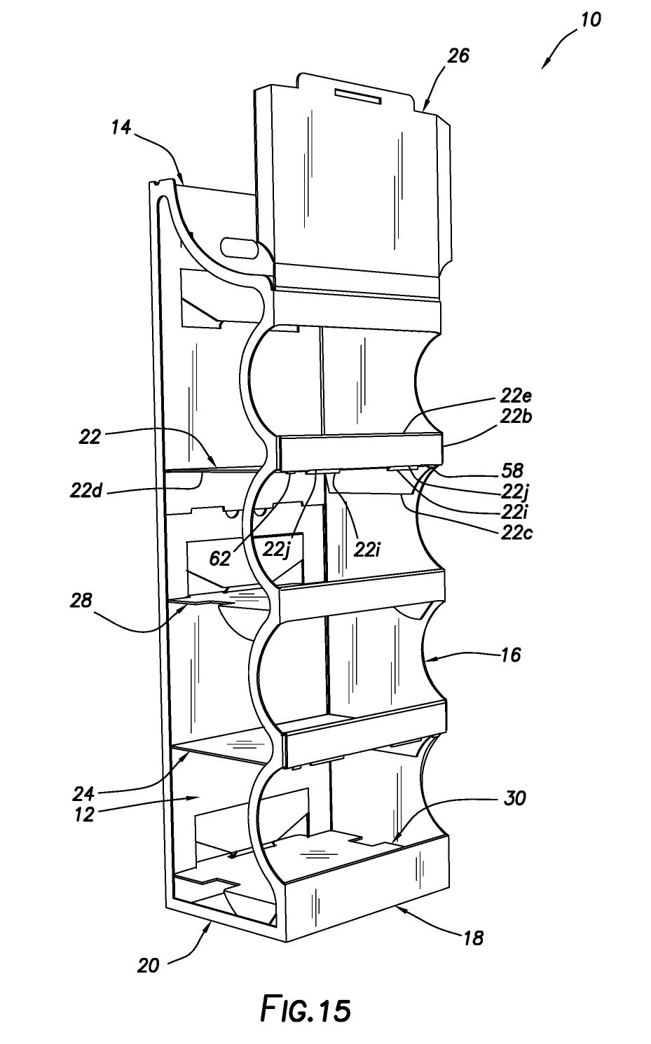

Referring additionally now to FIG. 15, a subsequent step of the method is representatively illustrated. In this view, it may be seen that the shelf section 22 has been folded in a manner similar to that described above for the shelf section 24. The shelf base 22d is now in a horizontal orientation, and is supported at its front, back and right sides as described above for the shelf base 24d.

Referring additionally now to FIG. 16, the fully erected display shelving 80 is representatively illustrated. In this view, it may be seen that the upper shelf section 26 has been folded in a manner similar to that described above for the shelf sections 28, 30. The shelf base 26d is now in a horizontal orientation, and is supported at its front, back, and right and left sides, as described above for the shelf bases 28d, 30d.

It will be appreciated that the display shelving 80 now comprises five shelves 82a-e, with each of the shelves comprising a corresponding one of the shelf sections 22, 24, 26, 28, 30 appropriately folded in the panels 12, 14, 16, 18, 20. Some of the shelves 82a,c,e are formed by folding respective shelf bases 26d, 28d, 30d of the front panel 18 rearward to engage the back panels 12, 14 (i.e., engaging the tabs 40 and 50, 48, 46 in the respective slots 66, 68, 70), and some of the shelves 82b,d are formed by folding respective shelf bases 22d, 24d of the inner back panel 12 forward to engage the front panel 18 (i.e., folding the lip sections 22a,b and 24a,b about the respective locking tabs 58, 62 and 60, 64).

Although the display shelving 80 described above comprises five shelves 82a-e, any number of shelves may be used in keeping with the principles of this disclosure. In addition, it is not necessary for there to be an unequal number of shelves folded forward and rearward, or for the number of shelves folded rearward to exceed the number of shelves folded forward.

It may now be fully appreciated that the above disclosure provides to the art significant improvements for display shelving blanks, display shelving, and methods of producing display shelving. In examples described above, the display shelving 80 can be economically produced from a single one-piece blank 10, and can be conveniently erected with multiple supported shelves 82a-e.

The above disclosure provides to the art a display shelving. In one example, a display shelving 80 can comprise a front panel 18, a back panel 12, 14, and side panels 16, 20 connecting the front panel 18 to the back panel 12, 14. A first shelf 82a is connected to the front panel 18 along a first fold line 26f, and the first shelf 82a is engaged with the back panel 12, 14. A second shelf 82b is connected to the back panel 12, 14 along a second fold line 22h, and the second shelf 82b is engaged with the side panels 16, 20 (e.g., supported by the side panels 16, 20 at a forward side of the second shelf 82b).

The front panel 18, the back panel 12, 14 and the side panels 16, 20 may be portions of a single one-piece blank 10.

The back panel may comprise inner and outer back panels 12, 14 secured to each other. The second shelf 82b may be connected to the inner back panel 12 along the second fold line 22h.

The display shelving 80 may comprise a third shelf 82c, the third shelf 82c being connected to the front panel 18 along a third fold line 28f, and the third shelf 82c being engaged with the back panel 12, 14. The second shelf 82b may be positioned vertically between the first and third shelves 82a,c.

The second shelf 82b may comprise first and second lip sections 22a,b that are folded around locking tabs 58, 62 of the side panels 16, 20.

The second lip section 22b may be connected to a shelf base 22d of the second shelf 82b along a third fold line 22f, and the first lip section 22a may be connected to the second lip section 22b along a fourth fold line 22e.

At least one tab 22i of the first lip section 22a may engage at least one slot 22j formed in the shelf base 22d.

The first shelf 82a may comprise a lip section 26a that is connected to a shelf base 26d along a third fold line 26g.

The back panel may comprise overlapping inner and outer back panels 12, 14. A tab 46 of the outer back panel 14 may engage a slot 66 formed in the shelf base 26d.

The first shelf 82a may further comprise support tabs 26c that extend downwardly from the shelf base 26d. Each of the support tabs 26c may be positioned adjacent a respective one of the side panels 16, 20.

A method of producing a display shelving 80 is also provided to the art by the above disclosure. In one example, the method may comprise: securing an inner back panel 12 to an outer back panel 14, with the inner and outer back panels 12, 14 overlying each other; connecting a front panel 18 to the inner and outer back panels 12, 14 with side panels 16, 20; folding a first shelf section 26 of the front panel 18 toward the inner and outer back panels 12, 14; and folding a second shelf section 22 of the inner back panel 12 toward the front panel 18.

The method may include engaging the first shelf section 26 with the outer back panel 14. The engaging step may include engaging a tab 46 of the outer back panel 14 with a slot 66 formed in the first shelf section 26.

The first shelf section 26 folding may comprise folding a lip section 26a of the first shelf section 26 along a first fold line 26g between the lip section 26a and a shelf base 26d of the first shelf section 26, and folding the lip section 26a along a second fold line 26f between the lip section 26a and the front panel 18.

The first shelf section 26 folding may comprise folding support tabs 26c of the first shelf section 26 downward, so that the support tabs 26c are positioned between the side panels 16, 20. Each of the support tabs 26 may be adjacent a respective one of the side panels 16, 20. A shelf base 26d of the first shelf section 26 may be positioned between the support tabs 26c.

The method may include engaging a forward side of the second shelf section 22 with locking tabs 58, 62 extending from the side panels 16, 20. The engaging step may include folding first and second lip sections 22a,b of the second shelf section 22 about the locking tabs 58, 62, so that the locking tabs 58, 62 are positioned between the first and second lip sections 22a,b.

The first and second lip sections 22a,b folding step may include folding the first lip section 22a toward the second lip section 22b along a first fold line 22e, and folding the second lip section 22b toward a shelf base 22d of the second shelf section 22 along a second fold line 22f.

The method may include producing a single one-piece blank 10 comprising the inner and outer back panels 12, 14, the front panel 18 and the side panels 16, 20.

The method may include folding a third shelf section 28 of the front panel 18 toward the inner and outer back panels 12, 14; and positioning the second shelf section 22 vertically between the first and third shelf sections 26, 28.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A display shelving, comprising:
a front panel;
a back panel; and
side panels connecting the front panel to the back panel,
wherein a first shelf is connected to the front panel along a first fold line, and the first shelf is engaged with the back panel, and
wherein a second shelf is connected to the back panel along a second fold line, and the second shelf is engaged with the side panels.

2. The display shelving of claim 1, wherein the front panel, the back panel and the side panels are portions of a single one-piece blank.

3. The display shelving of claim 1, wherein the back panel comprises inner and outer back panels secured to each other, and wherein the second shelf is connected to the inner back panel along the second fold line.

4. The display shelving of claim 1, further comprising:
a third shelf, the third shelf being connected to the front panel along a third fold line, and the third shelf being engaged with the back panel, and
wherein the second shelf is positioned vertically between the first and third shelves.

5. The display shelving of claim 1, wherein the second shelf comprises first and second lip sections that are folded around locking tabs of the side panels.

6. The display shelving of claim 5, wherein the second lip section is connected to a shelf base of the second shelf along a third fold line, and wherein the first lip section is connected to the second lip section along a fourth fold line.

7. The display shelving of claim 6, wherein at least one tab of the first lip section engages at least one slot formed in the shelf base.

8. The display shelving of claim 1, wherein the first shelf comprises a lip section that is connected to a shelf base along a third fold line.

9. The display shelving of claim 8, wherein the back panel comprises overlapping inner and outer back panels, and wherein a tab of the outer back panel engages a slot formed in the shelf base.

10. The display shelving of claim 9, wherein the first shelf further comprises support tabs that extend downwardly from the shelf base, and wherein each of the support tabs is positioned adjacent a respective one of the side panels.

11. A method of producing a display shelving, the method comprising:
securing an inner back panel to an outer back panel, with the inner and outer back panels overlying each other;
connecting a front panel to the inner and outer back panels with side panels;
folding a first shelf section of the front panel toward the inner and outer back panels; and
folding a second shelf section of the inner back panel toward the front panel.

12. The method of claim 11, further comprising engaging the first shelf section with the outer back panel.

13. The method of claim 12, wherein the engaging comprises engaging a tab of the outer back panel with a slot formed in the first shelf section.

14. The method of claim 11, wherein the first shelf section folding comprises folding a lip section of the first shelf section along a first fold line between the lip section and a shelf base of the first shelf section, and folding the lip section along a second fold line between the lip section and the front panel.

15. The method of claim 11, wherein the first shelf section folding comprises folding support tabs of the first shelf section downward, so that the support tabs are positioned between the side panels, each of the support tabs being adjacent a respective one of the side panels, and a shelf base of the first shelf section being positioned between the support tabs.

16. The method of claim 11, further comprising engaging a forward side of the second shelf section with locking tabs extending from the side panels.

17. The method of claim 16, wherein the engaging comprises folding first and second lip sections of the second shelf section about the locking tabs, so that the locking tabs are positioned between the first and second lip sections.

18. The method of claim 17, wherein the first and second lip sections folding comprises folding the first lip section toward the second lip section along a first fold line, and folding the second lip section toward a shelf base of the second shelf section along a second fold line.

19. The method of claim 11, further comprising producing a single one-piece blank comprising the inner and outer back panels, the front panel and the side panels.

20. The method of claim 11, further comprising:
folding a third shelf section of the front panel toward the inner and outer back panels; and
positioning the second shelf section vertically between the first and third shelf sections.
